(19) United States
(12) Patent Application Publication
(10) Pub. No.: US 2010/0057551 A1
(43) Pub. Date: Mar. 4, 2010

(54) POINT-OF-SALE PURCHASE SYSTEM AND METHOD WITH OPTION OF PAYMENT USING LOYALTY POINTS

(76) Inventor: Beth A. Blaisdell, Roswell, GA (US)

Correspondence Address: FOLEY & LARDNER LLP, 150 EAST GILMAN STREET, P.O. BOX 1497, MADISON, WI, 53701-1497, US

(21) Appl. No.: 12/200,589

(22) Filed: Aug. 28, 2008

(51) Int. Cl. G06Q 30/00; G06Q 20/00

(52) U.S. Cl. 705/14.27; 705/18

(57) ABSTRACT

One representative embodiment provides for the use of frequent flyer miles awarded to a customer by an airline as currency/alternative card type at the point-of-sale. For example, a customer dining at a restaurant can be given the option of paying with frequent flyer miles in addition to other traditional payment types. In such an implementation, the merchant swipes the frequent flyer card at the point-of-sale; the ‘conversion’ of the cost of the goods/services into frequent flyer miles is displayed for the customer; and the customer has the choice of completing the payment by frequent flyer miles or other traditional payment types. Settlement then occurs between merchant and a card processor and the card processor and the airline, respectively.

### FIELD

The subject of the disclosure relates generally to payment processing systems. More specifically, the disclosure relates to a processing system and method for a point-of-sale service providing customers with the option of payment using traditional payment means and/or loyalty points, such as frequent flyer miles.

### BACKGROUND

This Background section provides a context for the disclosure. The description herein may include concepts that could be pursued but are not necessarily ones that have been previously conceived or pursued. The description is not intended to be limiting and unless otherwise stated, nothing in this section is admitted as prior art simply by inclusion in this section.

Frequent flyer or customer reward programs have been used by airlines and other companies to promote customer loyalty and provide incentives for customers to purchase airplane tickets from the same carrier or for customers to purchase goods or services from the same vendor. The programs typically refer to the units that customers obtain for their purchases as “miles,” “points,” “rewards,” or other such designation. Depending on the program, customers can accrue “miles” or “points” that can be redeemed for airplane tickets or other products or services. In general, the number of miles or points needed for a particular ticket, product or service is set by the airline or company associated with the loyalty program.

A number of variations in loyalty programs have been proposed and implemented. Applicant is submitting a non-exhaustive list of patents and published patent applications with examples of such programs. As one example, U.S. Patent Application Publication 2006/0111973 entitled “Stored Value Mileage Card Systems and Methods of Use” describes a method in which a customer frequent flyer mileage account is debited by the mileage value associated with a purchase for the purchase of items or services. The patent application indicates that “[t]he items may include a meal, a beverage, a movie, a seat upgrade, and the like. The item may also be an item selected from a catalog, or otherwise available for purchase while traveling by airplane, train, bus, or the like.” (U.S. Patent Application Publication 2006/0111973, Paragraph [0011].)

Systems and methods for redeeming frequent flyer miles or loyalty points heretofore proposed and/or implemented have been limited. The disclosure herein describes representative systems and methods which improve customer's abilities to use miles or loyalty points as well as improve other aspects of these types of programs.

### SUMMARY

One representative embodiment provides for the use of frequent flyer miles awarded to a customer by an airline as currency or an alternative card type at the point-of-sale. For example, a customer dining at a restaurant can be given the option of paying with frequent flyer miles in addition to other traditional payment types. In such an implementation, the merchant swipes the frequent flyer card at the point-of-sale; the ‘conversion’ of the cost of the goods/services into frequent flyer miles is displayed for the customer; and the customer has the choice of completing the payment by frequent flyer miles or other traditional payment types. The customer must enter a Personal Identification Number (PIN) to allow for the transaction to take place. Settlement then occurs between merchant and a card processor and the card processor and the airline, respectively.

Another representative embodiment relates to a method for managing loyalty accounts including receiving from a point-of-sale device an account identifier and a purchase identifier, determining a rewards value corresponding to a balance in a loyalty account associated with the account identifier and deemed necessary to purchase an item identified by the purchase identifier, communicating the rewards value to the point-of-sale device, receiving from the point-of-sale device an authorization to use at least a portion of the reward value for at least a portion of a purchase price in a purchase transaction, and processing the purchase transaction.

Yet another representative embodiment relates to a system for managing loyalty accounts including a communication interface which receives an account identifier and a purchase identifier from a point-of-sale device, a database including loyalty account information for a loyalty account associated with the account identifier, and a processor programmed to determine a rewards value corresponding to units in the loyalty account and deemed necessary to purchase an item identified by the purchase identifier, and the processor further programmed to process a purchase transaction upon receiving from the point-of-sale device an authorization to use at least a portion of the reward value for at least a portion of a purchase price in the purchase transaction.

Yet still another representative embodiment relates to a method for managing a frequent flyer account which includes receiving from a point-of-sale device an account identifier for a frequent flyer account and a purchase identifier; determining a rewards value corresponding to frequent flyer miles in the frequent flyer account and deemed necessary to purchase an item identified by the purchase identifier; communicating the rewards value to the point-of-sale device; receiving from a point-of-sale device an authorization to use at least a portion of the reward value for at least a portion of a purchase price in a purchase transaction; and processing the purchase transaction including deducting the rewards value needed for the purchase transaction from the frequent flyer account.

Other principal features and advantages will become apparent to those skilled in the art upon review of the following drawings, the detailed description, and the appended claims.

### BRIEF DESCRIPTION OF THE DRAWINGS

Representative embodiments are hereafter described with reference to the accompanying drawings.

FIG. 1 is a flow diagram illustrating operations performed by a loyalty program management system in accordance with a representative embodiment.

FIG. 2 is a system diagram of the loyalty program management system of FIG. 1 in accordance with a representative embodiment.

FIG. 3 is a block diagram illustrating a frequent flyer program management system in accordance with a representative embodiment.

### DETAILED DESCRIPTION

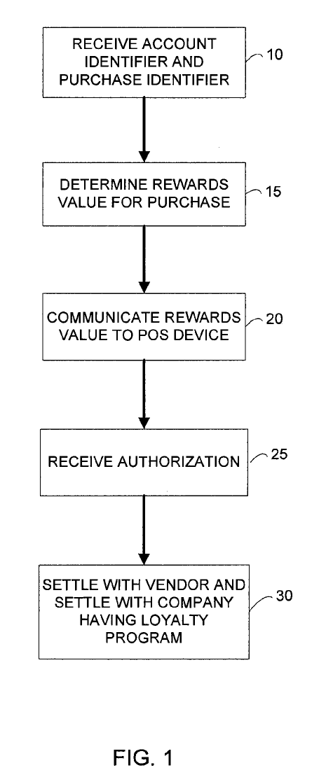

FIG. 1 illustrates a representative flow diagram depicting operations performed by a loyalty program management system. In alternative embodiments, fewer, additional, or different operations may be performed. In an operation 10, a processing system receives an account identifier and a purchase identifier from a point-of-sale device. The point-of-sale device can be a credit or debit card reader used by a customer or company employee to swipe a credit or debit card. In the representative embodiment, a loyalty card includes a magnetic strip which is readable by the card reader. The loyalty card is read by the reader and account information is communicated along with purchase information to the processing system. The loyalty card could be a frequent customer card or a multi-purpose card having the functionality of both a credit/debit card plus a frequent customer card. The device also has the ability to show the cardholder's balance. In one embodiment, the point of sale is not a physical location but an e-commerce web site accessible over the Internet. In another embodiment, the point-of-sale device is a handheld device such as a PDA, a smart phone, or other such device. The purchase identifer can include information such as the particular product or service being sold and a price for that product or service.

Electronic verification systems at the processing system allow merchants to verify that the card is valid and the cardholder has sufficient loyalty points to cover the purchase in a few seconds, allowing the verification to happen at time of purchase. According to a representative embodiment, the verification is performed using a credit card payment terminal or point-of-sale (POS) system with a communications link to the merchant's acquiring bank. Data from the card is obtained from a magnetic stripe or chip on the card.

In an operation 15, the processing system determines a rewards value corresponding to units in a loyalty account deemed necessary to purchase an item identified by the purchase identifier. The conversion from a currency such as U.S. dollars to rewards value can be done in a variety of different ways. In one implementation, the conversion factors in a level of reward status, such as a Gold, Silver, or Bronze status representing levels of total units in the loyalty account for a particular customer. For a “Gold” customer, the conversion from U.S. dollars to reward units may be $3 for every unit whereas the conversion for “Silver” customers is $2 per unit and for “Bronze” customer is $1. Alternatively, the conversion can take into account the vendor of the goods or services. For example, reward units may be valued higher when used at a particular hotel chain. As such the card “acquirer” (or processing system) used by the merchant, must have a communication link to the vendor, such as an airline, with the loyalty program to access frequent customer information.

In an operation 20, the processing system communicates the rewards value to the point-of-sale device. In one embodiment, the rewards value is displayed on the display of a card reader device. In another embodiment, the rewards value is displayed on a point-of-sale display screen coupled to the card reader device. The customer is given the opportunity to select purchasing the item using the rewards value. For example, along with the rewards value displayed on the card reader display, a “Yes or No” is displayed and the customer can push a “yes” or “no” button on the card reader unit. Thus, a customer wanting to buy a $20 novel at a bookstore can be presented at the card reader display with “Buy with 4,000 miles? Y/N.” In this instance, 4000 is determined to be the conversion from U.S. dollars to the reward units. The customer can accept or decline the purchase using reward units.

In an operation 25, the processing system receives an authorization to use at least a portion of the reward value for at least a portion of a purchase price in the purchase transaction. A representative embodiment only permits transactions where the purchase is done with 100% rewards units. However, in other embodiments, a portion of the purchase can be made using rewards units. For example, where a customer does not have enough reward units for the entire purchase, a discount or reduction in the price can be realized using reward units.

In an operation 30, the processing system performs settlements with the vendor and with the company associated with the loyalty account. Settlement with the vendor is carried out similar to credit or debit card transactions where the vendor account is credited and the customer account is debited.

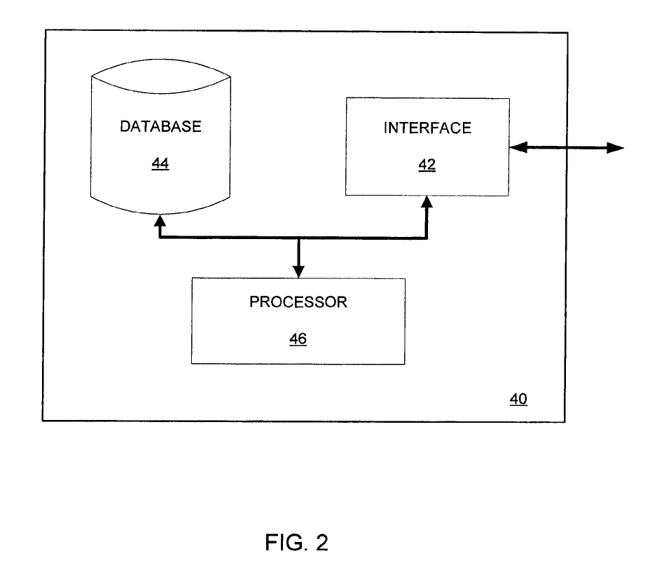

FIG. 2 illustrates a representative loyalty program management system 40 including a communication interface 42, a database 44, and a processor 46. Additional, fewer, or different components may be used depending on the implementation. The communication interface 42 receives an account identifier and a purchase identifier from a point-of-sale device and communicates reward unit information to the point-of-sale device. The database 44 has loyalty account information for a loyalty account associated with the account identifier. The loyalty account information can be obtained from the company associated with the loyalty program on a daily basis or some other time period. In one embodiment, the loyalty account information is updated in real time over the Internet.

The processor 46 includes programmed instructions to determine a rewards value corresponding to units in the loyalty account and deemed necessary to purchase an item identified by the purchase identifier. As discussed in reference to FIG. 1, a variety of different conversion conventions can be used to determine the rewards value of goods or services. The processor 46 is further programmed to process the purchase transaction upon receiving from the point-of-sale device an authorization to use the reward value for the purchase price in the purchase transaction. In a representative embodiment, the processor 46 receives authorization to use the reward value and processes the transaction as such. When the processor 44 receives authorization not to use the reward value but rather other payment means such as a credit card, the processor 46 processes the transaction as such. The credit card transaction may require input of a credit card at the point-of-sale device. However, the card used to identify the loyalty account may be a dual use card that serves as both a loyalty account identifier and a credit card identifier. In such an implementation, selection of which of the dual use functions is made by either the vendor or the customer or both.

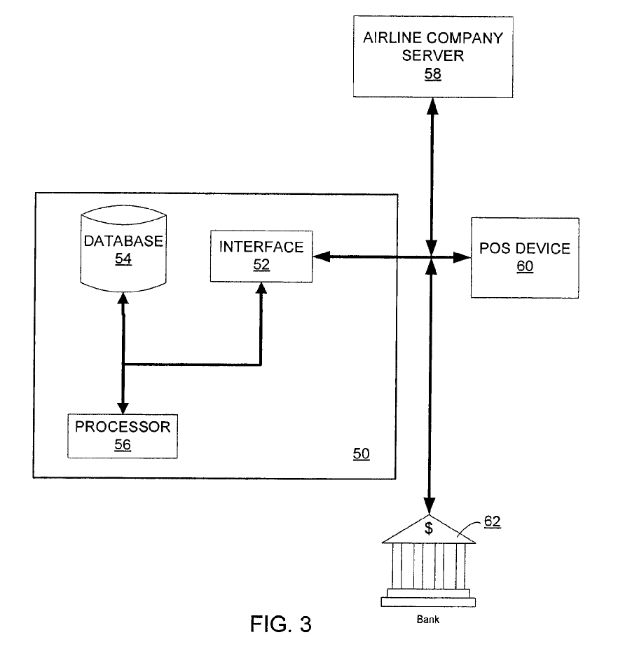

FIG. 3 illustrates a representative frequent flyer program management system 50 including a communication interface 52, a database 54, and a processor 56. Additional, fewer, or different components may be used depending on the implementation. The frequent flyer program management system 50 communicates with an airline company server 58 to obtain frequent flyer account information as well as to settle frequent flyer miles deductions (and possibly credits) resulting from purchases (and possibly returns).

The communication interface 52 facilitates communications with the airline company server 58, a point-of-sale device 60, and a financial institution 62. The point-of-sale device 60 send the frequent flyer program management system 50 frequent flyer account information, information regarding the goods or services to be purchased, and—in some implementations—credit or debit card information. The frequent flyer program management system 50 settles purchase transactions via the financial institution 62.

The loyalty or frequent flyer cards and transactions are processed in similar fashion to traditional card types. A clerk swipes a loyalty card or enters in the card number at the POS. The account or card number can be typed in to the POS device if the card is not available or if the magnetic stripe of the card does not work. Regardless of the means of entry, a PIN would still be required. When the transaction is sent in for authorization, the processor automatically determines what type of card it is using, for example, a pre-defined range of numbers. If a loyalty card; the processor verifies the balance available on that card and whether there are enough points to make the purchase by communicating to the airline or accessing the airline database directly. This information can be in the form of an accept/decline or, in the alternative, in the form of a ‘conversion’ amount and is provided back to the POS for the cardholder to decide how to make the payment. Funds are settled by the merchant's acquiring bank in which the acquirer pays the merchant the actual dollar amount of the sale less some fee. The merchant is paid in U.S. dollars and the loyalty company pays the acquirer in U.S. dollars in the agreed upon conversion rate. All merchant reports and cardholder receipts indicate either the U.S. dollar amount and/or the number of points or miles redeemed.

By way of example, a customer dining at a restaurant can be given the option of paying with frequent flyer miles in addition to other traditional payment types. In such an implementation, the merchant swipes the frequent flyer card at the point-of-sale device 60. The conversion of the cost of the restaurant bill into frequent flyer miles is displayed for the customer at the point-of-sale device 60 or on a bill printed from the point-of-sale device 60. The customer has the choice of completing the payment by frequent flyer miles or other traditional payment types. Settlement then occurs between the merchant operating the point-of-sale device 60 and a card processor operating the frequent flyer program management system 50 as well as between the frequent flyer program management system 50 and the airline.

The representative system provides a number of advantages to vendors with loyalty programs. First, it create new channels for mileage/point redemption. It profitably monetizes rewards liability, increases loyalty with additional high quality redemption options, improves the ability to manage load factors and customer satisfaction, and provides marketing information about loyal customers.

The representative system provides a number of advantages to customers having loyalty program accounts. It adds significant new value for loyal customers or frequent flyer members by enabling them to use loyalty points or frequent flyer miles to pay for goods and services at participating merchants. Customers can pay with miles instead of cash or credit, creating more ways to use miles/points for items the consumer values. It also provides the customer with the freedom to choose how to pay for items that consumer values instead of having to select from a small number of items in a catalog. The system provides the customer with the convenience to pay at point of purchase. Redemption of loyalty points is greatly simplified because there is no need to belong to multiple travel and entertainment related rewards programs. The customer also has the confidence in his or her ability to pay via anytime access to mileage/point balance.

The representative system provides a number of advantages to merchants. For example, the system provides lower “discount rates,” which are the fees the merchant pays the acquirer for processing the transactions. Merchants will also have incremental sales opportunities, brand association with World's Top Airlines/Merchants, co-marketing opportunities, and a seamless acceptance experience through retail, online, phone, mobile channels. Merchants get transaction processing, conversion to miles/points, back-end reconcilement/settlement and funding all from single-provider. The merchant's monthly processing statement will include totals for loyalty cards as well as traditional card types.

One or more flow diagrams and block diagrams have been used to describe exemplary embodiments. The use of flow diagrams is not meant to be limiting with respect to the order of operations performed. The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method for method for managing loyalty accounts, the method comprising:
receiving from a point-of-sale device an account identifier and a purchase identifier;
determining a rewards value corresponding to units in a loyalty account associated with account identifier and deemed necessary to purchase an item identified by the purchase identifier;
communicating the rewards value to the point-of-sale device;
receiving from a point-of-sale device an authorization to use at least a portion of the reward value for at least a portion of a purchase price in a purchase transaction; and
processing the purchase transaction.

2. The method of claim 1, wherein communicating the rewards value to the point-of-sale device comprises communicating frequent flyer miles necessary to purchase the item identified by the purchase identifier.

3. The method of claim 1, wherein processing the purchase transaction comprises performing a first payment settlement with a merchant associated with the point-of-sale device and performing a second payment settlement with a vendor associated with the loyalty account.

4. The method of claim 1, wherein processing the purchase transaction comprises deducting the rewards value from the loyalty account

5. The method of claim 1, wherein the purchase transaction is processed using a credit card account upon receipt of an indication to use a credit card.

6. The method of claim 1, wherein the purchase transaction is processed using the rewards value in the loyalty account for a first portion of the purchase transaction and a credit card account for a second portion of the purchase transaction upon receipt of instruction for partial payment of the item identified by the purchase identifier with a portion of the rewards value.

7. A system for managing loyalty accounts, the system comprising:
a communication interface which receives an account identifier and a purchase identifier from a point-of-sale device;
a database including loyalty account information for a loyalty account associated with the account identifier; and
a processor programmed to determine a rewards value corresponding to units in the loyalty account and deemed necessary to purchase an item identified by the purchase identifier, and the processor further programmed to process a purchase transaction upon receiving from the point-of-sale device an authorization to use at least a portion of the reward value for at least a portion of a purchase price in the purchase transaction.

8. The system of claim 7, wherein the loyalty account is a frequent flyer account.

9. The system of claim 7, wherein the processor processes the purchase transaction by performing a first payment settlement with a merchant associated with the point-of-sale device and performing a second payment settlement with a vendor associated with the loyalty account.

10. The system of claim 9, wherein the processor processes the purchase transaction by deducting the rewards value from the loyalty account.

11. The system of claim 7, wherein the purchase transaction is processed using a credit card account upon receipt of an indication to use a credit card.

12. The system of claim 7, wherein the purchase transaction is processed using the rewards value in the loyalty account for a first portion of the purchase transaction and a credit card account for a second portion of the purchase transaction upon receipt of instruction for partial payment of the item identified by the purchase identifier with a portion of the rewards value.

13. The system of claim 7, wherein the rewards value corresponding to units in the loyalty account and deemed necessary to purchase an item identified by the purchase identifier is determined based on a conversion factor of units to currency.

14. The system of claim 7, wherein the rewards value corresponding to units in the loyalty account and deemed necessary to purchase an item identified by the purchase identifier is determined based on a conversion factor of units to currency and an account status.

15. The system of claim 14, wherein the account status includes an indication of one of a plurality of levels of customer loyalty.

16. A method for managing a frequent flyer account, the method comprising:
receiving from a point-of-sale device an account identifier for a frequent flyer account and a purchase identifier;
determining a rewards value corresponding to frequent flyer miles in the frequent flyer account and deemed necessary to purchase an item identified by the purchase identifier;
communicating the rewards value and a total account miles value to the point-of-sale device;
receiving from a point-of-sale device an authorization to use at least a portion of the reward value for at least a portion of a purchase price in a purchase transaction; and
processing the purchase transaction including deducting the rewards value needed for the purchase transaction from the frequent flyer account.

17. The method of claim 16, wherein processing the purchase transaction comprises performing a first payment settlement with a merchant associated with the point-of-sale device and performing a second payment settlement with a vendor associated with the loyalty account.

18. The method of claim 16, wherein the purchase transaction is processed using a credit card account upon receipt of an indication to use a credit card.

19. The method of claim 16, wherein the account identifier is identified as corresponding to the frequent flyer account by determining that the account identifier falls within a range of numbers corresponding to frequent flyer accounts.

20. The method of claim 16, wherein the purchase identifier comprises information on a product or service and a corresponding price.
